(19) United States
(12) Patent Application Publication
(10) Pub. No.: US 2011/0047092 A1
(43) Pub. Date: Feb. 24, 2011

(54) SYSTEM AND METHOD FOR TRACKING AND MANAGING TRANSPORTATION OF SPECIMENS

(76) Inventor: H. Davis Taylor, Florence, SC (US)

Correspondence Address: NEXSEN PRUET, LLC, P.O. BOX 10648, GREENVILLE, SC, 29603, US

(21) Appl. No.: 12/917,924

(22) Filed: Nov. 2, 2010

Related U.S. Application Data
(63) Continuation-in-part of application No. 11/368,819, filed on Mar. 6, 2006, now abandoned.
(60) Provisional application No. 60/658,533, filed on Mar. 4, 2005.

(51) Int. Cl. G06Q 10/00; G06Q 90/00

(52) U.S. Cl. 705/333; 705/500

(57) ABSTRACT

The invention provides a system and method for tracking and managing transportation of specimens from a first location such as a medical office to a second location such as a testing lab for processing. A courier using a portable computing device can receive information when a specimen is ready for pick up from a first location. The courier will travel to a first location and enter specimen identification information into the portable computing device as well as first location information. Therefore, the portable computing device will have a record that the specimen has been picked up from the first location. The specimen is then carried to a second location and the courier enters the status of the specimen to show that it has been delivered to the second location for processing and a record exists to show that the specimen has been delivered to the second location. Lab results can be sent via the invention from the second location to the first location. A chain of custody and tracking system is therefore provided to reduce the risk of mishandled or even lost specimens and processing results.

### CLAIM OF PRIORITY

This application is a continuation-in-part of U.S. patent application Ser. No. 11/368,819, entitled SYSTEM AND METHOD FOR TRACKING AND MANAGING TRANSPORTATION OF SPECIMENS, filed Mar. 6, 2006, and incorporated herein by reference. This application claims further priority to U.S. Provisional Patent Application, Ser. No. 60/658,533, entitled SYSTEM AND METHOD FOR TRACKING AND MANAGING TRANSPORTATION OF MEDICAL SPECIMENS, filed Mar. 4, 2005, and incorporated herein by reference.

### FIELD OF THE INVENTION

This invention is directed to a system and method for tracking and managing the transportation of specimens such as medical specimens. More particularly, this invention is directed to a system and method for using a base computer system in communication with a handheld computer for scanning, tracking and maintaining chain of custody of medical specimens from source locations (first locations) to testing locations (second locations) for processing.

### BACKGROUND OF THE INVENTION

Medical specimens are used in a variety of ways. While most medical specimens are collected for health care at doctors' offices and hospitals, specimens are also collected for such applications as life insurance qualification, drug testing for employees and athletes, criminal investigation, and other forensic investigations. Collection of such specimens is not limited to human medial testing as specimens can be collected from animals, plants, or any number of sources.

Traditionally, once a medical specimen is collected, medical couriers transport the medical specimen from a collection source to a testing or processing lab. To maintain the chain of custody of the medical specimen and preserve the integrity of the test results, the possession of the medical specimen by the medical courier must be tracked and accounted for. Once a medical specimen is collected, the specimen can be associated with information from the collection source or first location. Such information can include patient number, location address, location number, crime scene number, or other such location identification. The specimen can have identification information that can be through the use of a barcode placed on the medical specimen container. The specimen is then transported to a second location such as a lab for processing or testing so that test results can be compiled based upon the need of those requesting the testing.

The results from testing of medical specimens can extraordinarily affect the source of the medical specimen. For example, the test results can be used to diagnose disease, to clear or convict a defendant in a criminal investigation, to determine whether employment may or may not be terminated and to determine eligibility for athletics. Significant problems arise when a medical specimen is lost, improperly identified, or improperly collected. Further, if the test results are not returned to the collection location, significant issues can arise. Improper identification, tracking, chain of custody and failure to return test result can lead to legal liability for the test requesting entity, the lab or the medical specimen courier. Further, such errors can result in improper criminal convictions, lack of criminal convictions, wrongful employment rejections or termination, tort liability for the medical specimen collector, lab or medical courier, and defamation of the medical specimen source. Imagine the liability incurred when an employee is terminated based upon a positive drug test due to test results from a medical specimen that was not collected from that employee. Further, imagine the liability were an employee addicted to drugs allowed to continue in a sensitive employment position such as child day care because the medical specimen for drug testing was lost.

Therefore, it is critical that the medical specimen identification be properly associated with the source, tracked, and a proper chain of custody maintained. It would be advantageous to provide for tracking reports and chain of custody reports that would show proper chain of custody, status of the lab testing, lab testing result information such as delivery date and date testing was preformed and other such management and administration desired by those skilled in the art.

Further, the medical courier can travel to many locations in a given week. Therefore, it would be advantageous that since the medical courier must routinely travel to the collection source and lab, that the medical courier can also track, maintain and stock inventory of supplier for the collection source or the lab.

### DESCRIPTION OF THE DRAWINGS

FIG. 1 is a schematic of component of the invention;

FIG. 2 is a flow chart of the operation of the invention; and,

FIG. 3 is a schematic of the operation of the PDA used with the invention.

### DETAILED DESCRIPTION OF THE INVENTION

The detailed description that follows may be presented in terms of program procedures executed on a computer or network of computers. These procedural descriptions are representations used by those skilled in the art to most effectively convey the substance of their work to others skilled in the art. These procedures herein described are generally a self-consistent sequence of steps leading to a desired result. These steps require physical manipulations of physical quantities such as electrical or magnetic signals capable of being stored, transferred, combined, compared, or otherwise manipulated readable medium that is designed to perform a specific task or tasks. Actual computer or executable code or computer readable code may not be contained within one file or one storage medium but may span several computers or storage mediums. The terms “host” and “server” may be hardware, software, or combination of hardware and software that provides the functionality described herein. This invention thereby allows multiple users, being geographically dispersed, to interact with data relating to physical characteristics of manufactured products using a system that ensures the precise and accurate conveyance of such information.

The present invention is described below with reference to flowchart illustrations of methods, apparatus (“systems”) and computer program products according to the invention. It will be understood that each block of a flowchart illustration can be implemented by a set of computer readable instructions or code. These computer readable instructions may be loaded onto a general purpose computer, special purpose computer, or other programmable data processing apparatus to produce a machine such that the instructions will execute on a computer or other data processing apparatus to create a means for implementing the functions specified in the flowchart block or blocks.

These computer readable instructions may also be stored in a computer readable medium that can direct a computer or other programmable data processing apparatus to function in a particular manner, such that the instructions stored in a computer readable medium produce an article of manufacture including instruction means that implement the functions specified in the flowchart block or blocks. Computer program instructions may also be loaded onto a computer or other programmable apparatus to produce a computer executed process such that the instructions are executed on the computer or other programmable apparatus providing steps for implementing the functions specified in the flowchart block or blocks. Accordingly, elements of the flowchart support combinations of means for performing the special functions, combination of steps for performing the specified functions and program instruction means for performing the specified functions. It will be understood that each block of the flowchart illustrations can be implemented by special purpose hardware based computer systems that perform the specified functions, or steps, or combinations of special purpose hardware or computer instructions. The present invention is now described more fully herein with reference to the drawings in which the preferred embodiment of the invention is shown. This invention may, however, be embodied in many different forms and should not be construed as limited to the embodiment set forth herein. Rather, these embodiments are provided so that this disclosure will be thorough and complete and will fully convey the scope of the invention to those skilled in the art.

The present invention tracks various information related to tracking medical specimens. Example of these types of data are status information, progress information, specimen identification information, first location information, second location information, and the like as described more fully below.

Progress information is tracked within at least two separate contexts. The first context that progress information is captured and tracked concerns the two states within which a specimen exists. The first state is captured when a courier scans the barcode identification of the specimen into the portable device at a first location. At this point the state of the specimen is considered to be picked-up and is noted as such by recording the specimen in the portable device database. Upon completion of the courier's route, the courier performs a Lab Scan that changes the state of the specimen from picked-up to delivered at a second location. The information contained in the portable device database is then synchronized with the medical courier elite (MCE) central database either in a single batch operation manually performed by the courier or it is synchronized automatically for MCE customers that choose to implement the optional real-time feature of MCE.

The second context within which progress information is captured and tracked concerns the geo-spatial location of the specimen. MCE customers that choose the optional GPS feature of MCE, receive the benefit of tracking the physical location of the specimen as it travels with the courier. The MCE mobile application running on portable computers equipped with GPS capture the current geo-spatial coordinates of the device at 30 second intervals, although any interval may be used as required for different kinds of specimens and differing requirements on details for tracking. The collection of geo-spatial coordinates associated with the portable device associated with the electronic specimen identification record stored in the portable device's database. Utilizing these GPS coordinates the courier company or pathology lab manager may view the current location and historical locations of the courier and the specimens that the courier is in custody of. The MCE portable device application has the programming code required to collect the geo-spatial location from the GPS device connected to the portable device. This programming code stores the geo-spatial coordinates as longitude and latitude in the portable device database. The information contained in the portable device database is synchronized with the MCE central database either in a single batch operation manually performed by the courier or it is synchronized automatically for MCE customers that choose to implement the optional real-time feature of MCE.

The geo-spatial coordinates of the courier are stored in a database table. This table contains specific GPS information such as Longitude, Latitude, Speed, Heading and a time-stamp of when the coordinate was captured. The individual GPS coordinates are related to a courier by the UserID field. Table 1 illustrates an embodiment of the information contained in this database table.

Specimen status information is stored in the portable device database. When a specimen is scanned into the portable device, a Site Visit record is created and associated with the Specimen record. The Site Visit Record contains the specific status information relating to the Site Visit where one or more specimens are picked-up. Table 2 illustrates an embodiment of the specific information that is captured and stored on the local portable device database.

The Specimen Record contains information related specifically to the specimen itself. Table 3 illustrates an embodiment of the database relationship for this information. The Specimen Record is associated with the Site Visit record by the SiteVisitID.

When the courier performs the Lab Scan/End Route function on the portable device, a Destination Visit record is created. The Destination Visit record is related to the Specimen Record through the DestinationVisitID. Table 4 illustrates an embodiment of the information that is captured and stored within the database on the portable device.

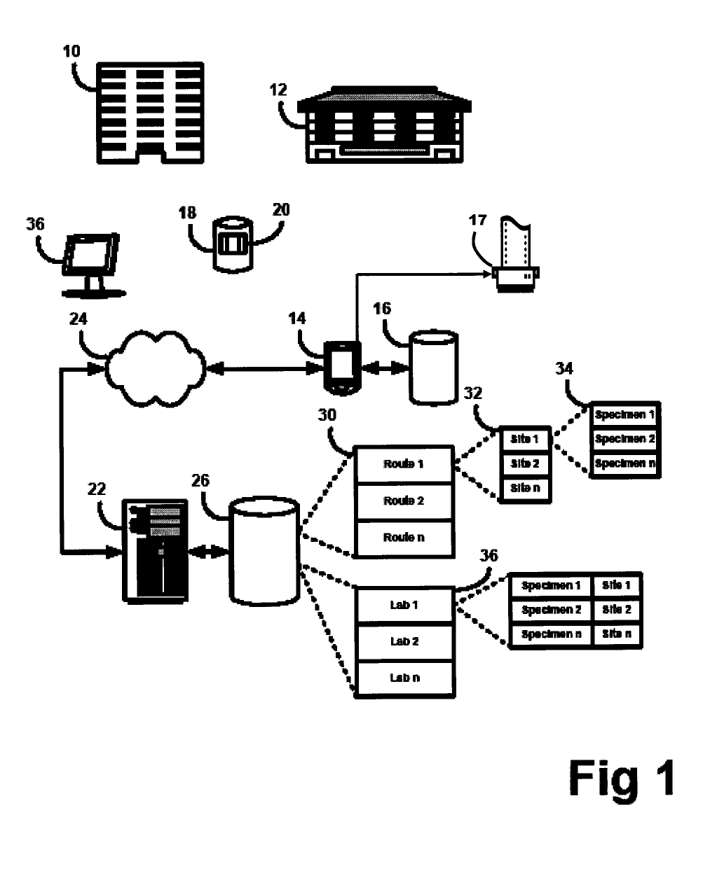

Referring now to FIG. 1, a system 5 for tracking and managing the transportation of medical specimens is illustrated. The illustrated embodiment may also be referred to as Medical Courier Elite® (MCE). A collection location or first location 10 is shown where medical specimens are collected for a variety of uses. A medical specimen, upon a request to be tested, is then transported to a second location such as a lab 12 for processing such as testing. A medical courier arrives at collection location 10 with a portable computing device 14, also referred to herein as a mobile device or portable device, having a portable computer readable medium 16. The medical specimen 18 is associated with specimen identification information 20 which can be entered, such as by scanning a barcode, in the portable device 14 so that the medical specimen identification information is stored in portable computer readable medium 16. Identification information 20 may be a bar code, a RFID tag, or any other known identifier. Additionally, the collection point information, first location process, and status information can each be stored in portable computer readable medium 16 and associated with the medical specimen.

Portable device 14 uses the MCE mobile application, which utilizes SQL Server CE to store all information in portable computer readable medium 16 required for the operation of the mobile application in the field. All identification, location, progress, and status information, as well as other data, required for operation is stored locally on the mobile device in portable computer readable medium 16 for at least two reasons. First, local storage provides faster performance in portable device 14 and system 5 overall. Second, network connectivity is not always reliable, so portable device 14 stores all information locally until it has a confirmed connection to network 24. The second reason is of increasingly lesser importance as connectivity means continue to improve as because portable device 14 may connect using any number of means, such as cellular, Wi-Fi, or wired network connectivity, or the like. When network 24 is not available to portable device 14, the system is designed to operate in a stand-alone manner. System 5 can also operate with periodic connections of portable device 14 to download and synchronize, as well as supporting real-time connectivity.

Portable device 14 may also include a mobile receipt printing capability to enable the user to print receipts while in the field. The mobile receipt printer 17 may be connected to portable device 14 using traditional serial-based wired connections or using the more contemporary Bluetooth Wireless connectivity.

The centralized hosted system, illustrated here as server 22 and computer readable medium 26, utilizes SQL Server for the storage of all system data, such as identification, location, progress, and status information. The SQL Server database is backed up at a location outside of the physical location of the main SQL Server database to ensure long term security of the system data.

Data communication between the various components of the system through network 24 may be accomplished utilizing ASP.NET Web Services technologies. ASP.NET Web Services implement the platform independent Simple Object Access Protocol (SOAP) for data exchange. Utilizing ASP.NET Web Services provides a secure and versatile method for this process.

All data transmission between the systems components that occur over the Internet through network 24 may be secured by utilizing Secure Sockets Layer (SSL) encryption. SSL is an industry standard for ensuring the privacy of data as it traverses the Internet.

System 5 uses logins and passwords for authentication and a role based mechanism for user authorization, whereby user logins are stored in the SQL Server databases in a one-way hashed encryption. It is very difficult to reverse-engineer or decrypt user passwords. To further secure the system, users are assigned a role when they are initially setup in the system. The particular role that a user is assigned will grant or deny authorization to particular system features.

When the specimens are collected they are tracked in a SQL CE database physically located on the portable computer's internal flash storage or external solid disk card. Each specimen is assigned a GUID (Globally Unique Identifier) that is associated with the scanned barcode. This is accomplished as follows. Specimen records are stored in the portable device database. When a specimen is scanned into the portable device, a Site Visit record is created and associated with the Specimen record. The Site Visit Record contains the specific status information relating to the Site Visit where one or more specimens are picked-up. Table 5 illustrates an embodiment of the specific information that is captured and stored on the local portable device database.

The Specimen Record contains information related specifically to the specimen itself. Table 6 illustrates an embodiment of that specific information. The Specimen Record is then associated with the Site Visit record by the SiteVisitID.

When the courier performs the Lab Scan/End Route function on the portable device, a Destination Visit record is created. The Destination Visit record is related to the Specimen Record through the DestinationVisitID. Table 7 illustrates an embodiment of the specific information that is captured and stored within the database on the portable device.

All subsequent actions taken related to this specimen will be associated with its related primary key in order to verify accuracy throughout the life cycle of the specimen. Site Visits track where a specimen was picked up, how long they were at a Site, and what Courier was operating the device.

All stored data on the portable device is then transferred to the central MCE server. The MCE central server hosts ASP.NET Web Services for the purpose of allowing the MCE portable devices to upload the specimen tracking data. ASP.NET Web Services are a platform independent Service Oriented Architecture (SOA) that provides a mechanism for client applications (MCE) to interface with server (host) applications. When the mobile device has network connection then it has the opportunity to transfer the specimen data from the local SQLCE database to the central hosted database of MCE.

The MCE Web Services interface specifically exposes a function (UploadCollectedData) for uploading the scanned specimen data. If the Lab has chosen to use the optional Real-Time feature of MCE, then the information is automatically uploaded to the central MCE database during the course of the day. If the Lab has chosen to not utilize the Real-Time feature then the information is uploaded to the central MCE database in a batch mode. The batch mode requires that the mobile device be placed in a docking station that has connectivity to the Internet. Once the device is docked and an Internet connection is established the mobile device user invokes the Synchronization function in MCE to initiate the upload of the data that has been stored in the local SQLCE database. The user initiates this process by clicking a button in the MCE Client Menu Screen. When the user clicks the button, the program builds an in-memory dataset with the specimen information and uploads the dataset to the MCE server application. The MCE server application receives the in-memory dataset and inserts records into the MCE host database for permanent storage and subsequent retrieval.

Other such information that can be collected upon the portable device receiving the medical specimen identification marking can include process or status information which can include date, time, medical courier identification, individual providing the specimen, location of the site where the specimen was retrieved, and other such information useful for maintaining a chain of custody of the medical specimen.

Once the medical specimen is retrieved from the collection location 10, it is transported to a second location such as testing facility 12 so that requested processing can be performed on the medical specimen. The medical specimen is then transported to testing location 12 by a medical courier who has portable device 14. Upon delivery of the medical specimen to the testing location, the specimen identification information is entered into portable device 14 so that portable computer readable medium 16 contains a record of the medical specimen being delivered to testing location 12. Additionally, processing information can be associated with the delivery of the medical specimen to the testing location such as date, time, person who has received the medical specimen at testing location, and medical courier identification.

All specimens that are picked up must be scanned back out at delivery to prove that nothing was lost. If a specimen is unable to be located for delivery it will be marked as a Specimen Alert. Specimen Alerts notify lab personnel of a lost specimen. Once the Specimen Alert is resolved—normally by finding the lost specimen or determining it was some other error—the lab personnel can mark a Specimen Alert as resolved, but must give a brief description so any future auditing will be satisfied. Once delivery of all specimens has been completed the lab personnel can pull many reports that give business intelligence, courier metrics, and logistics information that allow them to better organize their daily operations as well as ensure that they are handling all processes in the most efficient manner.

To facilitate the task of providing medical courier services, a route that the medical courier must travel can be uploaded to portable device 14 from a central server 22 via network 24. Portable device 14 can be in electronic communication with server 22 by such means as radio frequency, infrared, or wired communications such as through Internet network connections, or other such communication means. Since portable device 14 can be in electronic communication with server 22, information contained on the server's computer readable medium 26 can be transmitted to portable device 14 and stored in portable computer readable medium 16. Additionally, information from portable device 14 can be transmitted to server 22 and stored in the server's computer readable medium 26.

In one embodiment, information on server 22 can include the route information representing the path that the medical courier is to travel during a particular period of time. There can be one, two, or as many routes as the user wishes to designate transmitted to the portable device. By transmitting route information to the portable device, the medical courier can be provided with a route to be taken during the day. Full route information can be stored on computer readable medium 26 and is designated as 30 in FIG. 1. For each route, there can be one or more sites, designated as 32, associated with the route. For example, collection site 1 may be part of route 1 as well as collection site 2, shown as 32a. Therefore, route 1, when reviewed by the user, would show that site 1 is to be visited, and then site 2 is to be visited.

For each site, the medical courier retrieves each medical specimen that is present at the particular site and the medical specimen identification information for each specimen is associated with that site. The information associated with each specimen is shown as 34. Therefore, once the medical courier retrieves specimens from each site on each route, computer readable medium 16 can store process information such as route information 30, site information 32, and specimen information 34 reflecting the specimens that were collected, the site where the specimen was collected from, and the route where the site belongs. This information can be transmitted to server 22 and stored on the server's computer readable medium 26.

It is important to note that a route may also contain labs so that during a route, specimens can be dropped off at a particular lab, even between stops at specific sites. Lab information, shown as 36, can be stored in computer readable medium 26 or computer readable medium 16. When the medical courier travels to a lab 12, the specimens that are to be delivered to that lab are entered into the portable device 14 according to identification 20 and designated as delivered to lab 12. Therefore, the process of entering the identification information of a medical specimen allows the portable device to show which specimens are in the custody of the medical courier and which have been delivered to a lab for processing as well as process information such as time, date, location, and the individual who received the medical specimen. The lab can also be provided with the specimen information 34 and associated site information 32 when the medical specimen is delivered to the lab location 12.

In one embodiment, a GPS device is associated with portable device 14 so that when a medical specimen is retrieved from a first location or depository lab location, the location information can be associated with the transaction of receipt or delivery and stored in association with that particular medical specimen. The GPS device may be incorporated with portable device 14, or may be a stand-alone device.

The GPS data allows the lab to prove to clients that a courier was there at a certain time. GPS data is tracked for individual Site Visits as well as periodic “bread-crumbing” so that a Courier's route can be completely reconstructed. This bread-crumbing also allows lab personnel to better oversee their employees that are in the field.

GPS coordinates (or GPS data) is one type of tracking data. This and other aspects of tracking information would be “who” has custody of “what” specimen, “when” did this courier assume custody of the specimen and “where” was it picked-up (first location), “where” is it now (current GPS coordinates), and “where” and “when” was it delivered (second location). The collective information within the MCE database answers these questions. As shown in Table 7, the Site Visit record contains specific information regarding the “Who”, “When” and “Where” the courier was at the site (first location) for the purpose of picking-up specimens. Table 7 illustrates an embodiment of the specific data holding this what and when data.

Table 9 illustrates an embodiment of the Specimens records where the “what” and “when” data is stored.

The DestinationVisits record contains information regarding the delivery of the specimens. As shown in the embodiment of Table 10, this record answers the “where” and “when” the courier delivered and exchanged custody of the Specimens from the courier to the lab.

Thus portable device 14 can be “synchronized” with server 22 so that route information, site information, process information, status information, and lab information can be transmitted to portable device 14 and stored in portable device computer readable medium 16. Additionally, other information can also be transmitted to portable device 14 to assist in the administration and management of medical specimen transport. Such information can include users of the portable device, passwords, contact information for collection locations and lab locations, software update information transmitted from server 22 to portable device 14. Further, comments or notes associated with each route or site or lab can also be transmitted from server 22 to portable device 14 as well as from portable device 14 to server 22.

First location information can be specific to a site and can include the estimated time of arrival (ETA). This can be received from server 22 so that collection site 10 can inform the medical courier via portable device 14 that it requests medical specimen pickup at a particular time. In one embodiment, collection site 10 can access server 22 through client 36 and provide server 22 with a preferred pickup time so that server 22 can provide such information to the medical courier through portable device 14.

In one embodiment, the identification 20 of a medical specimen is a barcode and portable device 14 contains a barcode scanner for receiving the identification mark of the medical specimen.

When the medical courier is retrieving a medical specimen at site 10, site visit notes can be entered into portable device 14, stored in computer readable medium 16, transmitted to server 22, and stored in server computer readable medium 26. The site visit notes can be entered through alphanumeric keyboards or can be selected from predetermined site notes that will then be stored in portable device 14.

A signature can be obtained at a collection site 10 and entered into portable device 14 and stored in computer readable medium 16 as part of the process information. In one embodiment, once the signature is entered into portable device 14, subsequent retrieval of medical specimens from that particular collection site may be restricted. Therefore, the signature can represent such circumstances as collection site 10 verified that medical specimens were retrieved and the medical courier has completed receipt of all medical specimens to be picked up at that site.

When lab location 12 has medical specimens dropped off, identification mark 20 for each medical specimen is entered into portable device 14. Once the information is entered, the specimen can be removed from a drop-off list which, when such list is empty, indicates that each specimen to be delivered to that particular lab location has been delivered to the lab location and no specimens in the custody of the medical courier need to be dropped off. In the event that medical specimen information exists in the list associated with that particular lab location, the medical courier is informed that further specimens need to be dropped at that lab location.

Server 22 can contain an application for managing information and storing in computer readable medium 26. For example, a user interface can be used to maintain route information, site information, and lab information on server 22.

Operation of portable device 14, otherwise referred to as the mobile device in system 5, is equally flexible as can be seen from the following functionality in system 5.

Mobile Device Login: Before a user such as a courier can begin working a route, he or she must login to the mobile device application stored in portable computer readable medium 16. The first step is for the courier to enter valid user credentials. The courier then selects the appropriate username from a drop-down list box and then enters their password. If an invalid password is entered the user is denied use of the application. Once logged in to the mobile application, the user is required to select a route to run. Once a route is selected the courier is presented with the main menu.

Beginning on the main menu, the courier may view routes, view site visits, and perform the Lab Scan and End Route functions. As illustrated in Table 11, the Main Menu screen consists of buttons that the user typically taps with a stylus or their finger. The buttons display other screens on the portable device or initiate an action. In this embodiment, the Routes button displays a screen that allows the courier to select a route for the current day. The View Site Visits button displays the screen that presents information about the sites that have been visited. The Lab Scan/End Route button takes the courier to a screen where they can process the delivery (generally the second location) of the specimens.

Routes: As illustrated in the embodiment of Table 12, the courier may choose from this screen a particular route that has been assigned to him or her. Once the route is selected the courier may begin with a site visit. From the Routes screen, the courier selects the Route that they wish to run for the day.

Site Visit: The purpose of a site visit is generally to pick-up or drop-off a specimen at a lab or testing facility. As shown in Tables 13 through 15, a site visit will generally involve a number of steps for collecting information to be associated with the specimen record.

During the site visit, the courier scans the specimen identifier as shown in Table 13, which is typically a barcode on the surface of the specimen.

Once the barcode is scanned the courier may be prompted to specify some user defined properties about the specimen as shown in Table 14. The specimen definition is configurable by the lab manager.

Once all specimens have been scanned into the system, the courier acquires a signature from the site personnel and optionally prints a receipt to leave with the site as shown in Table 15.

It is typically during this site visit that the system first records the acquisition of a specimen and creates an electronic trail that may be used to account for the possession of and location of specimens.

Mobile Receipt Printing: The courier may also print a receipt using mobile printer 17 to be left with the site personnel or in a drop box. The mobile printer may be wired to the mobile device or connected using Bluetooth.

Lab Scan/End Route: Once the courier has completed the site visits, they return to the lab and drop off the specimens that they are transporting. Part of this process is the Lab Scan which is a cross-check of the specimens that were picked-up at sites and what has been delivered to the lab. If there are discrepancies in the specimens between what was picked-up and what was delivered, the courier is notified as to what is missing so that they can identify what is missing and locate the missing specimen. When the courier performs the Lab Scan and End Route, the specimen electronic records are updated accordingly to indicate the new status and location of each specimen as indicated by Tables 16 through 20.

Dispatch and Messages: The courier may receive at any time a critical site visit assignment from the lab manager or receive a message from the lab manager. This function provides electronic recording of notifications between lab managers and couriers as shown in Tables 21 and 22. If messages have been assigned, an acknowledgement requirement and the courier has not acknowledged the message in a user specified period of time, a notification is sent to the person that originated the message. The courier may also send messages from the mobile device to the lab manager. This provides a two-way communication mechanism with the added electronic record of the communication.

Support: The MCE system uses a web-based device management tool to provide system administrators with the ability to manage participating mobile devices from any computer that has Internet access and a compliant web browser such as Windows Internet Explorer. The remote device support infrastructure allows the system administrator to view the health of the mobile devices, the file system of the mobile device, and also remote control the user interface of the mobile device.

Real-time: The system offers an optional feature for labs that choose to operate portable device 14 in real-time. Using real-time functionality requires having an always-on Internet connection such as a Wireless Wide-area Network (WWAN) connection. This may be accomplished with any of the latest cellular technologies including but not limited to CDMA and GSM/GPRS wireless providers.

Connection management: Mobile device 14 includes network connection management functions. This feature provides the added benefit of utilizing a wired Ethernet or wireless Wi-Fi connection when not in cellular wireless coverage.

Automatic Updates: The system includes a mechanism for automatically updating the mobile devices that is transparent to the courier. This ensures that the MCE customers have the highest level of support with the least interruption to their work.

Specimen definition: Specimen definition is a means for a lab to assign user defined properties to the specimens that they collect. There is no real limit to the nature of these properties. These specimen definitions are completely configurable by the lab manager. During the process of scanning in the specimens on the mobile application, the courier is prompted to supply answers to the configured specimen definitions.

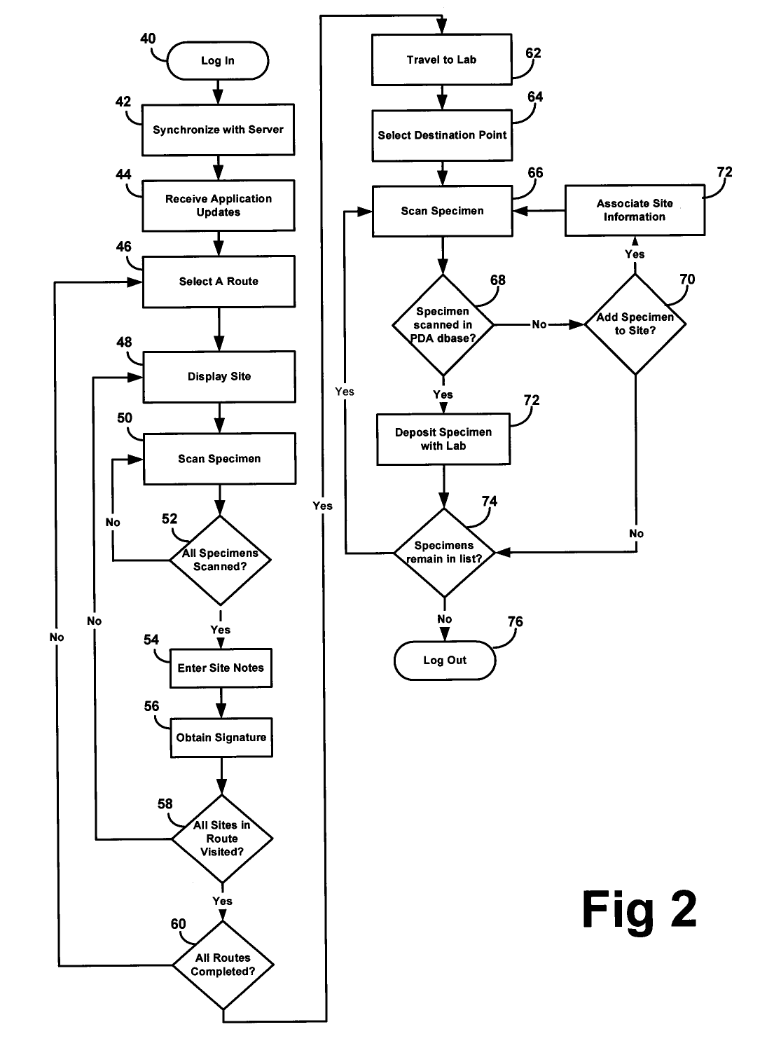

Referring now to FIG. 2, the operation of the invention will be described in more detail. In step 40, the user of portable device 14 logs in. The portable device can then be synchronized with server 22 in step 42. Portable device can then receive application updates in step 44, if any are present on server 22. In step 46, the user selects a route to travel which can include collection locations or lab locations. A pre-selected site according to the route is displayed for visiting at step 48, once the medical courier arrives at the selected site, a specimen can be entered into portable device 14, such as by scanning, at step 50. If there still remain specimens to be retrieved and scanned at step 52, the process returns to step 50 and continues.

When all specimens are scanned, site notes can be entered concerning a particular site at step 54 and a signature may be obtained at step 56 so that the medical courier is allowed to move on to the next site. A determination is made at step 58 as to whether all sites have been visited within the route. If not, the process returns to step 48 and begins again. If so, a determination is made at step 60 as to whether all routes are complete. If not, the process returns to step 46 for the next round, otherwise, the medical courier may travel to a lab at step 62. Upon reaching the particular destination point for the lab at step 64, the specimen to be deposited at the lab is scanned at step 66. A determination is made as to whether the scanned specimen exists in portable computer readable medium 16 of portable device 14. If not, the determination is made at step 70 as to whether to associate the scanned specimen that was not discovered in portable computer readable medium 16 with the specific site at step 70. Determination is made then in association of the site to the scanned specimen is made at step 72 and the process returns to step 66. If the determination at step 68 finds the specimen in computer readable medium 16, then the specimen is deposited with the lab location at step 72. The determination is made at step 74 as to whether there are specimens remaining in computer readable medium of portable device 14. If so, the process returns to step 66. If all specimens have been scanned and delivered to those lab locations, the user can log out at step 76.

Device activation: MCE authenticates mobile devices in normal use to prevent theft and unwanted access. An individual cannot obtain a device and connect to the MCE system. The MCE device activation mechanism utilizes unique information on each device to allow participation in the MCE system. Each mobile device has a unique Device ID that must be configured within the MCE system administration of MCE before a user can authenticate a device within MCE. Once the Device ID has been configured in MCE, the mobile device user will use the Activate the Device feature on the mobile device to complete the activation process. System 5 also includes an administrative web portal that uses GPS coordinates from portable device 14 for reporting location information, which can include among other things the current location of a courier, the current location of the mobile devices and historical location information for a courier over a period of time. The system may also use BING Mapping Technologies for providing a very rich and high resolution visual representation of the GPS location information as shown in Table 23. The web portal provides the lab admin the ability to view the locations of each courier. The couriers are generally depicted with a Human Bust type of icon.

The web portal provides the lab admin the ability to view the locations of each portable device as shown in Table 24. The portable devices are generally depicted with a PDA type of icon.

The web-based administrative portal also provides reporting features for users such as laboratory managers. SQL Server Reporting Services allows system 5 to create reports. The web-based administrative portal has a number of other features and those operate as follows.

Login: When a user browses to the URL for the web-based administrative portal, they are directed to the portal login page. The system utilizes ASP.NET Forms-based authentication for granting or denying access to the system. Upon providing authentic credentials the user is granted access to the administrative portal. The user's assigned role will grant or deny access (authorization) to various features in the portal. Users of the administrative web portal must login via this login page. The visitor is required to provide their Username, Password and Lab Domain. The user credentials are specific to a particular Lab Domain. The Lab Domain is a boundary separating the MCE customers. Each pathology lab has their own Lab Domain and their own set of authentic users.

System News: The initial landing page once authenticated into the system is the System News page. This page provides important news for the user so that he or she is alerted quickly when needed as illustrated in Table 25.

Messages: System 5 provides users such as lab managers the ability to send messages to mobile device users out in the field. While composing a message to a mobile user, the manager may optionally require that the mobile user acknowledge that they received the message. If the manager has required an acknowledgement then the mobile user will be required to send a response and indicate that they received the message. Lab Managers may also review all messages to-and-from couriers.

User Management: Users are added to the system typically by the MCE lab manager who is preferably an administrator level user. User profiles are entered and the user is assigned to one or more User Groups, also known as Roles. The assigned Role determines the level of authorized access that each user is granted. In a preferred embodiment, there are 7 predefined Roles in MCE: 1) Administrators, 2) Couriers, 3) CSR, 4) Dispatchers, 5) Report Viewers, 6) Route Managers, and 7) Site Users. Lab managers are top level users and may review all users that are configured within the system.

Sites Management: System 5 uses a site to represent a destination. Sites are entered into the system by entering a valid physical address. The system can use Geographic Information System (GIS) data acquired from an online GIS provider ESRI (www.esri.com) for geographic optimization of courier routes. Lab managers have the ability to view all Sites configured in the system as well as add new sites and modify existing sites.

Routes Management: The system uses a route to represent a series of locations that a courier is to visit during a specified time period. When a courier starts a work day, he or she selects a route to be run. The route provides the courier with the order of visits, the instructions for getting to the location and instructions on the arrival time and duration time of the visit. This is all done to optimize the work day of the courier so that the lab will provide the most efficient service to their customers. The lab manager may view and modify Routes that are configured in the system as illustrated in Table 26.

A route has properties that define how the route is to be run and what days the route is run on. Once a route is input, it must be defined as shown in Table 27.

Every route has one or more Sites defined as Site Visits as shown in Table 28.

Route Optimization and Planning: When a route is established, the lab manager or other administrator level user has the option to utilize the route optimization technology to order a route's site visits in the most geographically efficient order. Once the route has been optimized, the lab manager has the ability to over-ride the geographical optimization so that they can further apply advanced planning based on customer requirements or other variables such as traffic patterns. Once the route has been geographically optimized and then refined by the lab manager, the lab manager may lock one or more site visits into positions in the route.

Each route is comprised of one or more Site Visits. Each Site Visit is a physical location (address) somewhere on a map. Each of these locations has a geo-spatial location (longitude and latitude) that specify where on a map that site exists. MCE utilizes the geo-spatial coordinates for the purpose of determining the most efficient (geographical) order of the Site Visits within the route. To determine the most efficient geographical order of the array of addresses, MCE may utilize a service provided by ESRI, which is the preeminent provider of geocoded information services. MCE submits the unordered array of address to ESRI. In turn, ESRI returns to MCE the array (with longitude and latitude) that has been re-ordered in such a way that is the most geographically efficient order.

That in itself is not satisfactory for the purposes of MCE. Once MCE has the re-ordered array of sites on the route, MCE presents that to the lab manager for further optimization. Even though a route may be geographically optimized it may not be optimized based on business-case needs. Labs have some very large customers that require more than one site visit during a single day. In this case the multiple sites would be ordered together (geographically) but that is not optimal for the business needs of the lab manager.

After the route has been geographically optimized the lab manager uses the unique tools within MCE for the purpose of further optimizing the route based on business needs. Once the lab manager has finalized the optimal route based on geography and business requirements then it is ready for use by a courier.

A route optimization screen is shown in Table 29. The lab manager has a rich feature set for ordering the stops on the route and locking certain stops in a time window. The user interface utilizes most recent web programming technologies providing the lab manager with drag-and-drop functionality to manage the route.

Dispatches: The lab manager at times must respond to a critical customer request. The system also provides a mechanism for the lab manager to create an immediate critical site visit for a courier and introduce the site visit into their route. The mobile device user (courier) receives a dispatch, they are notified on the device and required to acknowledge that they received the dispatch. The Dispatch functionality requires the Real-Time feature of MCE.

Lab managers may view the status of Dispatches that have been issued to couriers as shown in Table 30.

Lab managers have the ability to issue new Dispatches as shown in Table 31.

The lab manager begins this part of the process by selecting the Client requiring the Dispatch as shown in Table 32.

Then the lab manager selects the person they were speaking with at the Client Site. The lab manager then sets some parameters indicating the urgency of the dispatch and if they wish to be notified when the site visit has been made. The date and time frame may be specified. The lab manager selects a route to issue the dispatch to. Then a review screen is presented to allow the lab manager to verify that all this information is input correctly as shown in Table 33. Once the lab manager clicks on Finish, a dispatch is issued to the selected Route, the courier receives an audible and visual alert and acknowledges that the dispatch was received.

GPS Tracking: As discussed above, system 5 uses GPS information gathered on the mobile devices. That is done for at least three different purposes: 1) Current Courier Location, which displays a map indicating the current location of each courier that is in the field; 2) Current Device Location, while similar to Current Courier Locations is based on device vs. courier; and 3) Individual Courier History provides a visual representation of the GPS location information for a specified courier over a period of time.

Settings: This feature provides the lab manager or other administrator level user a means of setting some of the static information for the lab. The settings page would be divided into at least three sections for lab settings, data settings, user settings, and the like.

Lab settings would in turn include the lab address, time zone, and lab password. It would also include a portal for managing and synchronizing portable devices, as well as a portal for training. Lab managers can in this way manage the portable devices that are configured in the system for their Lab Domain. They can also manage training sessions for users and clear out all of their training data to begin a new training session. The lab manager also has complete control over action items used within the MCE system.

Data settings would include among other things contact information that is provided to the couriers on the portable devices.

The lab manager can also control user settings for things such as User defined Contact Types to be used within MCE. The lab manager maintains the list of Specimen Definition items to be used by the couriers on the portable devices. The lab manager also maintains the list of Dispatch Types that are available to select from when a dispatch is issued to a route. This is a user definable list of codes that the courier has to select from when they deviate from the route. The lab manager may also change the Admin password for their Lab Domain.

Specimen Search: This useful feature provides the user with a very quick way of finding a particular specimen and viewing the entire history of the specimen.

Reporting: The system provides a variety of management reports to display courier performance and historical tracking of the specimens.

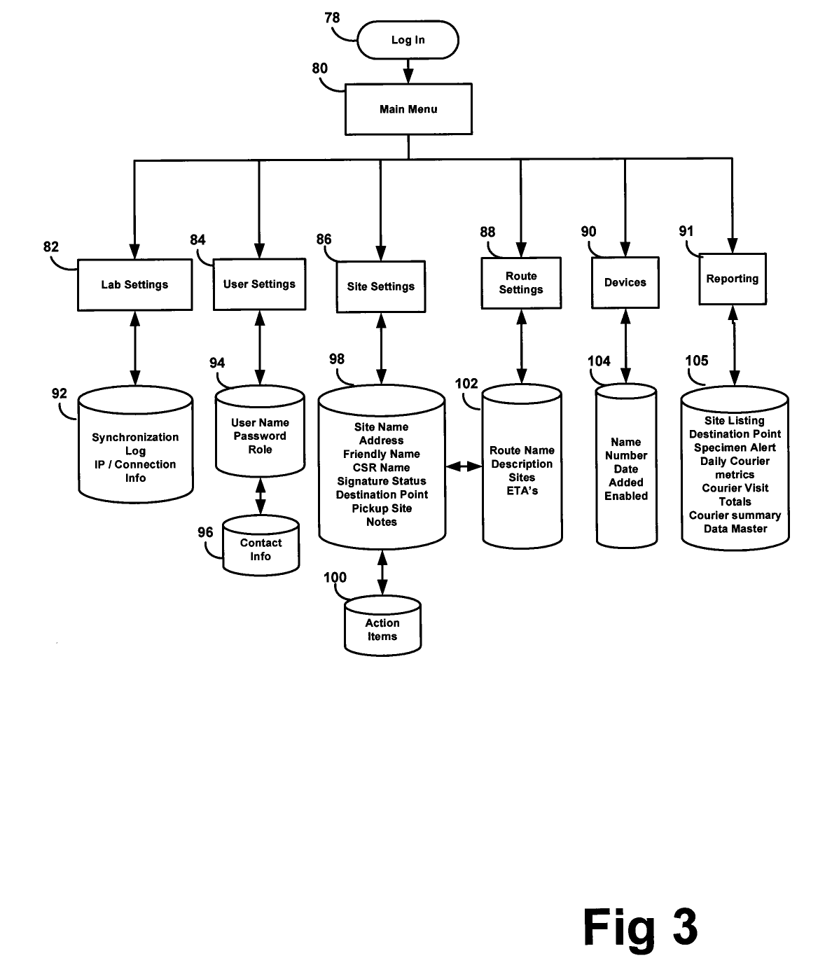

Referring now to FIG. 3, an explanation of the operation of server 22 is shown in more detail. The user can log onto the server at step 78. A main menu can be displayed at step 80. The main menu can direct the user to lab settings at step 82, user settings at step 84, site settings at step 86, route settings at step 88, device settings at step 90, and report settings at step 91. Lab settings can include such information, designated as 92, as synchronization log, lab location, connection information, and other information. User settings can include such information, designated as 94, as user name, password, and role. The role of a user can include: administrators which connect to portable device 14 or server 22 and have full access; couriers which can access portable device applications, run reports, review synchronization logs, and receive announcements from server 22; client service representative (CSR) which is a service representative for particular sites; report viewers which allow these users to review reports; route managers which are given, generally, full access to portable device 14 and server 22, with the exception of modifying lab settings and site users which allow individuals to view specimen information, but restricted to only those sites associated with the site user. Contact information for user can also be accessed under user setting designated as 96. Site settings can include the site name, address, family name, customer service rep name, signature status, destination point, pickup site, and notes designated as 98 as well as action by those designated as 100. Action items can include notes, messages or other information to be transmitted to portable device 14 for review by the user of the portable device. Route settings can include route name, description, site information, and estimated times for the medical courier to arrive at the particular site in that route. This information is designated generally as 102. Device information can include the name, the number, the date the device was added to the system, and whether the device is enabled, or not. This information is designated generally as 104. Reporting settings can include such information, designated as 105, as site listing reports, destination point reports, specimen alert reports, daily courier metrics reports, courier visit reports, total reports, courier summary reports and data master reports.

Further, inventory information concerning supplies for particular sites can be stored in either service computer readable medium 26 or the portable computer readable medium 16. Information can then be maintained at portable device 14 so that the medical courier can take inventory at a particular site, drop off inventory, and maintain information for the inventory for a particular site. Such information concerning inventory can include historical records for inventory requests, inventory fulfillments, and comparison of inventory use for particular specimens received from the particular site. Since portable device 14 is in communication with server 22, information stored on portable device computer readable medium 16 can be received by server 20 and stored on computer readable medium 26. This would allow a user to access server 22 through network 24 using a terminal 36 and be provided with reports and information concerning inventory and specimen status. For example, a collection site user could access terminal 36 and discover when and what specimens were delivered to what lab location. Further, the lab location could also access server 22 through terminal 36 that would allow the lab to update the status of the specimen. Such information associated with the specimen could include the date the specimen was tested, the date the specimen was received, the medical courier who delivered it, the time and date it was delivered, as well as even attach the lab report itself and associate such information to the specimen.

Information that can be transmitted to portable device 14 for the medical courier to include is a checklist to ensure proper procedures are followed by the medical courier. Information that can be included in such a checklist can include that the courier must acknowledge that all receipts and deliveries have been completed, supplies have been accounted for, and the specific sites and lab locations of a route have been visited.

In one embodiment, a photograph can be taken and entered into the portable device to provide further process information associated with the site, the specimen, or the lab location. A camera, digital or otherwise, can be connected to portable device 14.

When a specimen is delivered to a lab, the portable device 14 can also be used to track the specimen within the lab at various points during the testing procedure. This can allow for the medical specimen to be associated with specific tasks and locations within the lab to provide even more information concerning chain of custody, testing process, and status of the medical specimen. The lab location can also enter the specimen identification mark, such as by scanning the specimen, and since the lab can have access to server 22 in computer readable medium 26, specimen information, even including the testing information, can be transmitted and recorded by server 22, for a complete and comprehensive collection, tracking, and management of information concerning the receipt, delivery, testing, and results of the medical specimen. This information can be accessed by the user of the collection location to even receive the report information from the testing location. The invention may be better understood by reviewing the attached user manual herein fully incorporated by reference.

These illustrated examples are offered by way of illustration of the invention's versatility and not meant to limit the invention in any way. The present invention may be embodied in other specific forms without departing from its spirit of essential characteristics. The described embodiments are to be considered in all respects only illustrative and not restrictive. The scope of the invention is therefore indicated by the appended claims rather than by the foregoing description. All changes which come within the meaning and scope of equivalency of the claims are to be embraced within their scope.

What is claimed is:

1. A system for tracking a medical specimen obtained from one location through multiple locations thereafter comprising:
a central computer with a computer readable medium;
status information stored in said computer readable medium and associated with a specimen;
first location information stored in said computer readable medium;
second location information stored in said computer readable medium;
progress information representing the progress of the processing of said specimen stored in said computer readable medium; and,
a set of computer readable instructions embodied in said computer readable medium for receiving specimen identification information associated with a specimen origination from said first location, associating said specimen identification with said first location information so that the origination of said specimen is known, receiving progress information representing that said specimen has been picked up from said first location, updating said status information representing that said specimen has been picked up from said first location, receiving progress information representing that said specimen has been delivered to said second location, associating said second location information with said specimen identification information, and updating said status information representing that said specimen has been delivered to said second location so that the physical location of the specimen can be tracked during the processing of the specimen; and
a portable computing device in communication with said central computer, comprising:
a portable computer readable medium;
a second set of computer readable instructions embodied in said portable computer readable medium for receiving said specimen identification information associated with a specimen origination from said first location, associating said specimen identification with said first location information so that the origination of said specimen is known, receiving progress information representing that said specimen has been picked up from said first location, updating said status information representing that said specimen has been picked up from said first location, receiving progress information representing that said specimen has been delivered to said second location, associating said second location information with said specimen identification information, and updating said status information representing that said specimen has been delivered to said second location so that the physical location of the specimen can be tracked during the processing of the specimen.

2. The system of claim 1 wherein said second set of computer readable instructions include instructions for transmitting said process information from said portable computer readable medium to said computer readable medium.

3. The system of claim 2 wherein said second set of computer readable instructions include instructions for receiving said first location information from said computer readable medium.

4. The system of claim 2 wherein said second set of computer readable instructions include instructions for receiving said second location information from said computer readable medium.

5. The system of claim 1 wherein said second set of computer readable instructions include instructions for receiving progress information from said computer readable medium associated with said specimen identification information representing that said specimen is ready for pick up from said first location.

6. The system of claim 1 wherein said second set of computer readable instructions include instructions for comparing said specimen identification information stored in said portable computer readable medium with said specimen identification information contained on said specimen at said first location to determine if said specimen at said first location is the correct specimen for pick up.

7. The system of claim 1 wherein said second set of computer readable instructions include instructions for comparing said specimen identification information and said associated second location information stored in said portable computer readable medium with said specimen identification information contained on said specimen to determine if said specimen has been delivered to the correct second location.

8. The system of claim 1 wherein said second set of computer readable instructions include instructions for indicating whether said process information indicates if said specimen has been picked up from said first location, but not delivered to the said second location.

9. The system of claim 1 wherein said computer readable instructions include instructions for receiving a plurality of specimen identification information, receiving a plurality of first location information wherein each specimen identification information is associated with a first location information, receiving progress information for each one of said plurality of specimen information indicating that said specimens are ready for pickup, and determining a route between said first plurality of locations so that said plurality of specimens can be picked up according to said route.

10. A system for tracking a specimen having identification information originating at a first location for processing at a second location comprising:
a computer readable medium;
status information stored in said computer readable medium and associated with said specimen;
first location information stored in said computer readable medium;
second location information stored in said computer readable medium;
progress information representing the progress of the processing of said specimen stored in said computer readable medium; and
a set of computer readable instructions embodied in said computer readable medium for receiving specimen identification information associated with a specimen origination from said first location, associating said specimen identification with said first location information so that the origin of said specimen is known, receiving progress information representing that said specimen has been picked up from said first location, updating said status information representing that said specimen has been picked up from said first location, receiving progress information representing that said specimen has been delivered to said second location, associating said second location information with said specimen identification information, updating said status information representing that said specimen has been delivered to said second location so that the physical location of the specimen can be tracked during the processing of the specimen, transmitting said status information to a portable computing device so that a user of said portable computing device will know the status of the specimen.

11. The system of claim 10 wherein said computer readable instructions include instructions for receiving progress information representing that said specimen has been picked up from said second location, updating said status information representing that said specimen has been picked up from said second location, receiving progress information representing that said specimen has been delivered to said first location, updating said status information representing that said specimen has been delivered to said first location.

12. The system of claim 10 wherein said computer readable instructions include instructions for receiving progress information representing that said specimen has been processed at said second location and updating said status information representing that said specimen has been processed.

13. The system of claim 10 wherein said computer readable instructions include instructions for receiving a status request requesting the status of said specimen, retrieving said status information from said computer readable medium, and transmitting a notification to said first location representing the status of said specimen according to said status information.

14. The system of claim 10 wherein said computer readable instructions include instructions for receiving progress information representing that processing results resulting from processing said specimen are available at said second location and updating said status information representing that processing results resulting from processing said specimen are available at said second location.

15. The system of claim 14 wherein said computer readable instructions include instructions for transmitting said processing results to said first location so that said first location is provided with the processing results from said second location.

16. The system of claim 14 wherein said computer readable instructions include instructions for receiving progress information representing that the processing results have been picked up from said second location, updating said status information representing that the processing results have been picked up from said second location, reviewing processing information representing that the processing results have been delivered to said first location, and updating said status information representing that the processing results have been delivered to said first location.

17. The system of claim 10 wherein said computer readable instructions include instructions for transmitting said status information to a portable computing device so that a user of said portable computing device will know the status of the specimen.

18. The system of claim 10 wherein said computer readable instructions include instructions for receiving a specimen identification information from said first location, receiving progress information from said first location indicating that said specimen is ready for pick-up from said first location, and updating said status information representing that said specimen is ready for pick-up from said first location.

19. The system of claim 10 wherein said computer readable instructions include instructions for receiving a plurality of specimen identification information from a plurality of first locations, receiving progress information from each of said first locations indicating that said plurality of specimens are ready for pick-up, and determining a route between said plurality of said first location so that said plurality of specimens can be picked-up according to said route.

20. The system of claim 10 wherein said computer readable instructions include instructions for transmitting said route to a portable computing device used by a specimen carrier so that the carrier is provided a route for specimen pick-ups.

21. A system for tracking a specimen wherein a specimen courier uses a portable computing device comprising:
a portable computer readable medium; and
a set of portable computer readable instructions embodied in said portable computer readable medium for receiving specimen identification information from said computer readable medium, receiving process information from said compute readable medium representing that said specimen is ready for pick up from said first location, receiving process information from the courier that said specimen has been picked up from said first location, transmitting said process information to said computer readable medium representing that said specimen has been picked up, receiving process information from the courier representing that said specimen has been delivered to said second location, and transmitting said process information to said computer readable medium representing that said specimen has been delivered to said second location.

22. The system of claim 21 wherein said computer readable instructions include instructions for generating a chain of custody report representing the status of said specimen at particular times and at particular locations.

23. The system of claim 21 wherein said computer readable instructions includes instructions for generating a drop-off list representing that said specimen is to be delivered to said second location.

24. A system for tracking a specimen having identification information originating at a first location for processing at a second location comprising: a portable computer readable medium in communications with a central computer readable medium; first location information embodied in said portable computer readable medium; second location information embodied in said portable computer readable medium; and, a set of portable computer readable instructions embodied in said portable computer readable medium for receiving specimen identification information, associating said specimen identification information with said first location information, generating process information representing that said specimen has been picked up from said first location, generating process information indicating that said specimen has been delivered to said second location, and associating said second location information with said specimen information.

25. The system of claim 24 wherein said portable computer readable instructions include instructions for transmitting said process information to said central computer readable medium.

26. The system of claim 25 wherein said portable computer readable instructions include instructions for receiving said first location information from said central computer readable medium.

27. The system of claim 25 wherein said portable computer readable instructions include instructions for receiving said second location information from said central computer readable medium.

28. The system of claim 24 wherein said portable computer readable instructions include instructions for receiving progress information from said central computer readable medium associated with said specimen identification information representing that said specimen is ready for pick up from said first location.

29. The system of claim 24 wherein said portable computer readable instructions include instructions for comparing said specimen identification information stored in said portable computer readable medium with said specimen identification information contained on said specimen at said first location to determine if said specimen at said first location is the correct specimen for pick up.

30. The system of claim 24 wherein said portable computer readable instructions include instructions for comparing said specimen identification information and said associated second location information stored in said portable computer readable medium with said specimen identification information contained on said specimen to determine if said specimen has been delivered to the correct second location.

31. The system of claim 24 wherein said portable computer readable instructions include instructions for indicating whether said process information indicates if said specimen has been picked up from said first location, but not delivered to the said second location.

32. The system of claim 21 wherein said computer readable instructions include instructions for receiving a plurality of specimen identification information, receiving a plurality of first location information wherein each specimen identification information is associated with a first location information, receiving progress information for each one of said plurality of specimen information indicating that said specimens are ready for pickup, and determining a route between said first plurality of locations so that said plurality of specimens can be picked up according to said route.

33. A method of tracking a specimen having identification information and associated status information originating from a first location having first location information for processing at a second location having second location information, said method comprising the steps of:
receiving specimen identification information;
associating a first location information with said specimen identification information;
picking up a specimen from a first location;
updating status information indicating that said specimen has been picked up from said first location;
delivering said specimen to a second location for processing;
associating second location information with said specimen identification information; and;
updating said status information indicating that said specimen has been delivered to said second location.

34. The method of claim 33 including the steps of comparing said status information with said specimen identification information located on said specimen to determine if the specimen is the correct specimen to pick up.

35. The method of claim 33 including the steps of reviewing said status information to determine if said specimen has been delivered to said second location.

36. The method of claim 33 including the steps of comparing said status information with the physical location of said specimen to determine if said specimen is at the correct location.

37. The method of claim 33 including the steps of comparing said status information with the physical location of said specimen to determine if said status information currently reflects the physical location of said specimen.
